(19) United States
(12) Patent Application Publication
(10) Pub. No.: US 2005/0093737 A1
(43) Pub. Date: May 5, 2005

(54) Device and method for phase shifting

(76) Inventor: Joerg Schoebel, Salzgitter (DE)

Correspondence Address: KENYON & KENYON, ONE BROADWAY, NEW YORK, NY, 10004, US

(21) Appl. No.: 10/946,639

(22) Filed: Sep. 21, 2004

(30) Foreign Application Priority Data
Nov. 5, 2003 (DE) 103 51 506.2

(51) Int. Cl. G01S 13/93

(52) U.S. Cl. 342/175; 342/70; 342/71; 342/72

(57) ABSTRACT

A device and a method for phase shifting on at least one single-layer or multilayer substrate, in particular a substrate also having at least one metallic layer, to which is applied at least one planar line, in particular in the form of a strip line or in the form of a symmetrical or asymmetrical coplanar line or in the form of a microstrip line or in the form of a slot line or in the form of a coplanar dual-strip line so that the advantages of a slow-wave structure may also be used in mechanically controllable phase shifters, the phase shift is adjustable by varying the effective dielectric constant, in particular the propagation coefficient, of the line by providing line sections going out from the line, in particular no-load line sections and/or in particular line sections short-circuited at their particular ends and/or stubs going out from the line and/or alternating line segments of a high impedance and line segments of a low impedance and/or discrete elements such as inductors, capacitors or inductive and/or capacitive line bridges and/or in particular discrete serial and/or parallel reactances and/or in particular discrete serial and/or parallel susceptances and/or in particular effective line quantities per unit length such as capacitance per unit length, e.g., transverse capacitance per unit length, or inductance per unit length, e.g., longitudinal inductance per unit length.

### RELATED APPLICATION INFORMATION

This application claims the benefit and priority of German patent application no. 103 51 506.2, which was filed in Germany on Nov. 5, 2003, and the disclosure of which is hereby incorporated in its entirety.

### FIELD OF THE INVENTION

The present invention relates to a device for phase shifting on at least one single-layer or multilayer substrate, in particular a substrate also having at least one metallic layer, to which is applied at least one planar line, in particular in the form of a strip line or in the form of a symmetrical or asymmetrical coplanar line or in the form of a microstrip line or in the form of a slot line or in the form of a coplanar dual-strip line. The present invention also relates to a method for phase shifting on at least one single-layer or multilayer substrate, in particular a substrate also having at least one metallic layer and having at least one planar line, in particular in the form of a strip line or in the form of a symmetrical or asymmetrical coplanar line or in the form of a microstrip line or in the form of a slot line or in the form of a coplanar dual-strip line.

### BACKGROUND INFORMATION

For radar-based range finders in transportation arrangements, in particular in motor vehicles, microwave antennas having electronically pivotable or switchable beam lobes have been investigated, such antennas usually being designed as group antennas.

In this connection, there are various arrangements for phase-controlled group antennas (“phased arrays”) having a pivotable beam lobe and for phase shifters, and there is also literature in this regard (see R. J. Mailloux, “Phased Array Antenna Handbook,” Artech House, Boston, London, 1994; D. M. Pozar, D. H. Schaubert, “Microstrip Antennas,” IEEE Press, New York, 1995; S. K. Koul, B. Bhat, “Microwave and Millimeter Wave Phase Shifters,” Vol. 1 and Vol. 2, Artech House, Boston, London, 1991).

Planar antennas having dipole emitters, patch emitters, or slot emitters are constructed on this microwave substrate. Details in this regard may be found, for example, in the description by P. Bhartia, K. V. S. Rao, R. S. Tomar, “Millimeter-Wave Microstrip and Printed Circuit Antennas,” Artech House, Boston, London, 1991.

In triggering such a group antenna G (see FIG. 1A and FIG. 1B), the transmission signal coming from a signal source Q (see FIG. 1A and FIG. 1B) is first split by at least one power divider L (see FIG. 1A and FIG. 1B) according to a predetermined amplitude distribution among the M columns and/or the N rows of group antenna G.

The beam is pivoted in the plane and/or in the two planes perpendicular to the columns and/or the rows of group antenna G by mutually shifting the phases of the signals emitted via individual antenna elements R (see FIG. 1A and FIG. 1B) by switchable phase shifters P (see FIG. 1A and FIG. 1B).

FIG. 1A shows the basic design of such a triggering for a phase-controlled group antenna G (phased array); FIG. 1B shows a phased-array group antenna having a one-dimensionally pivotable beam lobe, i.e., pivotable in one plane (=azimuth A), rows of multiple series-fed antenna elements R1, R2, R3 forming group antenna G being used in the second dimension (=elevation E) to bundle the beam lobe more greatly in elevation E.

FIG. 2A, FIG. 2B, and FIG. 2C show examples of additional possible configurations of the feed to antenna columns (see P. Bhartia, K. V. S. Rao, R. S. Tomar, “Millimeter-Wave Microstrip and Printed Circuit Antennas,” Artech House, Boston, London, 1991):
in series feed 22s according to FIG. 2A, there is an electric path length between antenna elements 32, 34, 36, 38 by which a fixed beam deflection may be set in elevation E, for example;
in corporate feed 22g according to FIG. 2B, all antenna elements 32, 34, 36, 38 are fed the same phase, the amplitude normally decreasing symmetrically toward the outside to reduce secondary lobes;
phase-symmetrical and/or amplitude-symmetrical feed 22p according to FIG. 2C is a combination of series feed 22s (see FIG. 2A) and corporate feed 22g (see FIG. 2B); here antenna elements 32, 34, 36, 38 need not necessarily receive in-phase feed, but the phase differences and the amplitude assignment are symmetrical and furthermore the feed network here is smaller than that with corporate feed 22g.

Another way to trigger a group antenna G is depicted in FIG. 3A and in FIG. 3B, where antenna elements R (see FIG. 3A) and/or antenna elements R1, R2, R3 (see FIG. 3B) do not receive a parallel feed as in FIG. 1A and/or FIG. 1B but instead receive a series feed. The phase shifting here is not created between the input signal and the signal of the column but instead relatively between the columns.

FIG. 3A shows a detail of the basic design of a phased array having series feed 22s made available via a signal source Q and having phase shifters P between antenna elements R. FIG. 3B shows schematically the design of a phased array having series feed 22s made available via a signal source Q and having phase shifters P between antenna elements R1, R2, R3 having a one-dimensionally pivotable beam lobe (=azimuth A), rows having multiple antenna elements R1, R2, R3 being used in the second dimension (=elevation E).

With regard to H[igh]F[requency] lines and planar antennas, planar HF lines such as coplanar lines, microstrip lines, slot lines, or the like are used today to construct inexpensive HF circuits.

As an example, these three types of planar lines are diagramed with the particular basic plot of the electric field of the basic mode
as a (symmetrical or asymmetrical) coplanar line (=“coplanar waveguide”) in FIG. 4A,
as a microstrip line in FIG. 4B and
as a slot line in FIG. 4C.

Apart from the planar line types shown in FIG. 4A, FIG. 4B, and FIG. 4C, there are many other types of planar line, such as strip lines or coplanar dual-strip lines (see, for example, R. K. Hoffmann, “Integrierte Mikrowellenschaltungen” [Integrated Microwave Circuits], Springer-Verlag, Berlin, 1983).

Furthermore, the following modifications may occur:
metallic coating of the underside of the substrate;
multilayer substrates, metallic layers also being possible;
dielectric layers covering the metallic printed conductors.

Special microwave substrates such as glass, ceramics, or plastics, optionally combined with fillers or reinforced with glass fibers, or the like may be used as the substrate.

With mechanically controllable phase shifters, the principle of dielectric loading is essentially already known from the related art. One way of implementing a mechanically controllable phase shifter is discussed for example by S. K. Koul, B. Bhat, “Microwave and Millimeter Wave Phase Shifters,” Vol. 1 and Vol. 2, Artech House, Boston, London, 1991. The principle of dielectric loading here with mechanically controllable phase shifters involves changing the effective dielectric constant of a line. To this end, the material surrounding the planar line is altered in the case of planar lines (see FIG. 4A, FIG. 4B, and FIG. 4C) such as microstrip lines (see FIG. 4B) or strip lines (see page 73 in S. K. Koul, B. Bhat, “Microwave and Millimeter Wave Phase Shifters,” Vol. 1 and Vol. 2, Artech House, Boston, London, 1991), for example, by
shifting a sheet of dielectric material over the line and/or
changing the distance of this sheet of dielectric material from the surface of the line.

This principle may also be applied to other planar lines such as coplanar lines, slot lines, and a plurality of symmetrical and asymmetrical strip lines. By analogy with this, the effective dielectric constant of a hollow conductor may also be changed by shifting a piece of dielectric material within the hollow conductor (see page 75 in S. K. Koul, B. Bhat, “Microwave and Millimeter Wave Phase Shifters,” Vol. 1 and Vol. 2, Artech House, Boston, London, 1991).

The maximum achievable phase shift on a certain length of the mechanical phase shifter is relatively limited by the influence of the surrounding material on the effective dielectric constant of the line. In the case of a planar line, effective dielectric constant ∈_{eff} is approximately
∈_{eff}=0.5(∈_{r,substrate}+∈_{r,coverlayer})
with dielectric constant ∈_{r,substrate} of substrate 10 and dielectric constant ∈_{r,coverlayer} of the dielectric cover layer, i.e., dielectric material 40.

Phase-angle deviation Δφ per unit length for a mechanical phase shifter based on lines for T[ransverse] E[lectro] M[agnetic] waves, i.e., lines for electromagnetic waves without field components in the propagation direction (see H.-G. Unger, “Elektromagnetische Wellen auf Leitungen” [Electromagnetic Waves on Lines], third edition, Hüthig-Verlag, Heidelberg, 1991), is obtained as follows
Δφ/length=β₂−β₁=ω·(μ₀·∈₀·∈₂)^{1/2}−ω·(μ₀·∈₀·∈₁)^{1/2}=(2π/λ₀·(∈₁^{1/2}−∈₁^{1/2})
with first effective dielectric constant ∈₁
(<--> no cover layer or a cover layer of a first material and/or in a first position, e.g. at a great distance), second effective dielectric constant ∈₂
(<--> cover layer of a second material and/or in a second position, e.g., at a slight distance) and free space wavelength λ₀.

In addition, the maximum achievable phase-angle deviation of a mechanical phase shifter based on the principle of dielectric loading is determined by the maximum tolerable misadjustment. In other words, line impedance Z changes with the change in effective dielectric constant ∈_{eff} of the line according to the equation
Z₂/Z₁=(∈₁/∈₂)/^{1/2},
if it is assumed that the change in the cover layer influences only the capacitance per unit length but not the inductance per unit length of the line.

Line impedances Z₁ and Z₂ of the mechanical phase shifter are usually placed symmetrically around system line impedance Z₀ with Z₁>Z₀ and Z₂<Z₀ for ∈₁<∈₂ to uniformly minimize the reflectance in the two phase states.

In addition to dielectric loading, the field distribution (and thus the effective dielectric constant) of a planar tine i's also influenceable by:
shifting a sheet of conductive material a certain distance over the line and/or
varying the distance of this sheet of conductive material from the surface of the line.

An alternate way for implementing a mechanically controlled phase shifter is to have an influence on the effective dielectric constant of a dielectric waveguide by varying the distance of a conductive element from the waveguide.

This principle is also utilized in International patent publication WO 00/54368, which discusses implementing beam pivoting by mechanically moving a conducting sheet up and down over a dielectric waveguide (called a scanning antenna having mechanically controlled phase shifting).

FIG. 5 shows the basic design of this available arrangement in the form of a scanning antenna T having mechanically controllable phase shifting by dielectric loading of a dielectric waveguide W having a metallic element V.

Antenna T generates a scanning beam lobe for radar and communications applications, for which an electromagnetic wave is guided in dielectric waveguide W. Some of the power of the electromagnetic wave is output through apertures U to conductive patches S according to a series feed as shown in FIG. 3A.

At the same time, the reflector (=element V) of conductive material moves up and down in the direction of dielectric waveguide W so that the size of gap X between dielectric waveguide W and reflector V is varied. This creates a phase shifting of the electromagnetic wave in waveguide W by varying the evanescent fields of dielectric waveguide W as a function of the position of reflector V.

This structure which is known from publication WO 00/54368 A1 has some technical HF problems and manufacturing problems:
(i) the material of dielectric waveguide W is not specified, so the HF losses are unclear; thermal matching to the substrate material is required;
(ii) manufacturing of dielectric waveguide W on a structured substrate (<--> output to patches S) or structuring of the substrate after application of waveguide W (compatibility of the material of waveguide W with the structuring process);
(iii) input of the HF signal, usually from a planar line (presumably a microstrip) into dielectric waveguide W.

In view of the embodiments known from the related art, another factor to be considered is that propagation coefficient β of a line and impedance Z of a line are derived from the line quantities per unit length, namely longitudinal inductance L′ per unit length and transverse capacitance C′ per unit length, which
depend inherently on the line geometry in the case of a “classical” line and
are interlinked in the case of (quasi-)TEM lines according to the formula L′·C′=μ₀·∈₀·∈_{eff} (see H.-G. Unger, “Elektro-magnetische Wellen auf Leitungen” [Electromagnetic Waves on Lines],” third edition, Huthig-Verlag, Heidelberg, 1991).

This means that propagation coefficient
β=ω·(L′·C′)^{1/2}=ω·(μ₀·∈₀·∈_{eff})^{1/2}
of a planar (quasi-)TEM line may be adjusted only in a small range of variation because propagation coefficient β is influenceable only via effective dielectric constant ∈_{eff} if magnetic materials having μᵣ>1 are ruled out for practical reasons.

Since the electric field of planar lines is always divided approximately into half on the substrate and half in the space above the substrate (except microstrip lines which have somewhat greater proportions of the electric field in the substrate), the following equation always holds approximately for effective dielectric constant ∈_{eff}:
∈_{eff}=0.5·(∈_{r,substrate}+∈_{r,coverlayer}).

Therefore, effective dielectric constant ∈_{eff} is influenced very little by the line geometry.

A slow-wave structure is a line whose propagation velocity v=/ω/β is small in relation to the propagation velocity achievable with a “classical” line under the same boundary conditions (dimension(s), cover layer(s), frequency, metallic coating, substrate material, and the like).

Effective line quantities per unit length are usually created here by macroscopic structures which are small in comparison with the wavelength and/or whose mutual distance is small in comparison with the wavelength. For this reason, these macroscopic structures are also referred to as distributed slow-wave structures (in differentiation from the stub-loaded line structures to be discussed below).

In this context, propagation velocity/may be influenced by two different principles (i) and (ii) illustrated on the basis of FIG. 6A and FIG. 6B:
(i) According to FIG. 6A, the line (=coplanar line 20k) has short line segments 28h, 28n having alternating high and low impedance, the particular length of line segments 28h, 28n being smaller than the wavelength. A line segment 28h of a high impedance creates in particular effective (longitudinal) inductance L′ per unit length. A line segment 28n having a low impedance creates in particular effective (transverse) capacitance C′ per unit length (see FIG. 6A, where this slow-wave structure formed by coplanar line 20k is shown with alternating sections 28h of a high line impedance and sections 28n of a low line impedance).
(ii) According to FIG. 6B, (longitudinal) inductance L′ per unit length is generated by a “classical” line (=microstrip line 20m), and (transverse) capacitance C′ per unit length is increased by stubs 26 going out from this planar line 20m and/or by discrete capacitors at periodic distances which are smaller than the wavelength. To generate required line impedance Z, classical line 20 is usually designed with a high resistance, i.e., more inductive than the required line impedance (see FIG. 6B, which shows this slow-wave structure with the high resistance (narrow) microstrip line 20m and (short) no-load stubs 26 which depart from this microstrip line 20m and generate additional capacitance C′ per unit length).

The transition between these two principles (i) and (ii) is fluid and is determined less by physical factors (a short broadened line segment 28n may also be interpreted as a short broad stub 26), but in particular is determined by the more convenient augmentation and computation for the particular geometry.

Instead of no-load lines, short-circuited lines may also be used at their ends. Alternatively or additionally, discrete elements such as inductors, capacitors or inductive and/or capacitive line bridges may be used, e.g., like those in M[icro]E[lectro]M[echanical]S[witches] phase shifters (see for example pages 72 to 81 in G. M. Rebeiz, G.-L. Tan, J. S. Hayden: “RF MEMS Phase Shifters: Design and Applications,” IEEE Microwave Magazine, June 2002).

Examples of slow-wave structures include, for example:
U.S. Pat. No. 6,242,992 discusses or refers to a resonator having a coplanar line in the slots of which there are interdigital fingers which alternately lead from signal strips and from ground strips (see FIG. 6A); the slow-wave structure suppresses higher resonator modes and/or shifts these higher resonator modes toward higher frequencies; this structure follows principle (i) described above, i.e., that of a classical coplanar line in whose slot there are capacitors formed by interdigital fingers;
U.S. Pat. No. 6,313,716 discusses or refers to a slow-wave delay line in a meandering structure having line segments of alternating high and low impedance (see preceding principle (i)) and
International patent application WO 91/19329 discusses or refers to a slow-wave microstrip line having bridges alternating with M[etal]I[nsulator]M[etal] capacitors (see principle (ii) above).

Stub-loaded line structures and distributed loaded line phase shifters with MEMS (see for example pages 72 through 81 in G. M. Rebeiz, G.-L. Tan, J. S. Hayden: “RF MEMS Phase Shifters: Design and Applications,” IEEE Microwave Magazine, June 2002), which are to be described below, may be assigned to slow-wave structures according to the principle.

With regard to stub-loaded line phase shifters, phase shifters whose function is based on activation or switching of two series reactances or two parallel reactances (called shunts) having a distance of approximately one fourth of the line wavelength are described by R. E. Collin, “Foundations for Microwave Engineering,” second edition, McGraw-Hill International Editions, New York, 1992, pages 411 ff and S. K. Koul, B. Bhat, “Microwave and Millimeter Wave Phase Shifters,” Vol. 1 and Vol. 2, Artech House, Boston, London, 1991, pages 408 ff.

The parallel reactances here may be formed by lines (stubs) concluded with a short-circuit or no-load at their ends. Likewise, however, discrete inductors or discrete capacitors or combinations of lines and discrete reactances may also be used.

The design of a stub-loaded line phase shifter may follow one of the two principles (i) and/or (ii) illustrated below on the basis of FIG. 7A (=first principle or first type) and FIG. 7B (=second principle or second type). The computation is described in detail by R. E. Collin in “Foundations for Microwave Engineering,” second edition, McGraw-Hill International Editions, New York, 1992, pages 411 ff and in S. K. Koul, B. Bhat, “Microwave and Millimeter Wave Phase Shifters,” Vol. 1 and Vol. 2, Artech House, Boston, London, 1991, pages 408 ff:
(i) Connecting the reactances to the line for a second phase state, i.e., connecting two susceptances jB at distance θ:
   In a first phase state the reactances are separated by the line. This principle is illustrated in FIG. 7A for a susceptance jB in a parallel circuit. Distance θ and variable B of the susceptances jB may be selected so that the desired phase shift is achieved and both the first phase state and the second phase state are ideally adapted. In practical terms, typical phase shifts of 45° and under some circumstances up to 90° are achieved.
(ii) Switching between reactances of the same absolute value but different signs for the two phase states, i.e., switching between susceptances +jB and −jB at distance λ/4.
   The distance between the two reactances amounts to one fourth of line wavelength λ. Thus the two reflectances of the two reactances only approximately cancel one another in contrast with principle (i). This principle is illustrated in FIG. 7B for susceptances +jB and −jB in a parallel circuit. The desired phase shift is specified by the size of the susceptances +jB and −jB and is limited to smaller values than for principle (i) because of the maladjustment. Typical phase shifts of 22.5° are achievable under practical conditions.

Based on the disadvantages and inadequacies explained above and taking into account the related art as outlined, the object of the exemplary embodiment and/or exemplary method of the present invention is to provide a device and method of the type discussed above so that the advantages of a slow-wave structure may also be used in mechanically controllable phase shifters.

This object is achieved by the exemplary device having the features described herein and by the exemplary method having the features described herein. Advantageous embodiments and expedient refinements of the exemplary embodiment and/or exemplary method of the present invention are described herein.

The exemplary embodiment and/or exemplary method of the present invention is thus based on the use of a slow-wave structure or a stub-loaded line phase shifter (also being a slow-wave structure) in a mechanically controllable phase shifter, i.e., the exemplary embodiment and/or exemplary method of the present invention includes a mechanical phase shifter having a planar slow-wave structure and a method for operating same.

According to a particularly inventive refinement of the present device as well as the present method, the mechanical influence on the phase shifter may be achieved
by varying the distance and/or
by varying the lateral position of one or more
dielectric elements optionally having different dielectric constants, in particular dielectric caps or dielectric sheets and/or
conducting elements, in particular conducting caps or conducting sheets over the entire structure of the phase shifter or over parts of the structure, e.g., over only the stubs.

Not least of all in application cases that are of particular interest for an automobile radar, the advantages of the exemplary embodiment and/or exemplary method of the present invention are based on a greater phase-angle deviation with respect to the length of the phase shifter in the slow-wave structure in comparison with mechanically controlled phase shifters based on the principle of dielectric loading of a planar line, for example. At the same time, a planar slow-wave structure is easily manufacturable.

Another advantage of the exemplary embodiment and/or exemplary method of the present invention is that mechanical phase shifters equipped with a planar slow-wave structure have in good approximation a true-time delay behavior, i.e., a phase-controlled group antenna will emit all the frequency components of broadband signals, e.g., U[ltra]W[ide]B[and] pulse radar in the same direction.

The present mechanical phase shifter which is implemented with a slow-wave structure may be used in the following exemplary application areas that may be essential to the exemplary embodiment and/or exemplary method of the present invention:
(i) Beam pivoting on phase-controlled group antennas, e.g., in an angle scanning (automobile) radar having beam pivoting through mechanical phase shifters: The slow-wave phase shifter here replaces the complex and therefore relatively expensive manufacturing of the dielectric waveguide structure in the beam pivoting antenna according to publication WO 00/54368 A1 (see FIG. 5). The phase on a planar slow-wave structure may be controlled mechanically just like the phase of the dielectric waveguide but the slow-wave structure is easier and less expensive to manufacture (standard etching process on a microwave substrate, inexpensive Teflon substrates possible).
(ii) Setting the elevation angle of the beam lobe of a radar antenna by a cap or ra[dar]dom[e]:
   The slow-wave structure allows introduction of the required phase shift in a direct connection between two patch elements (see FIGS. 3A and 3B) without requiring bypass lines which are difficult to accommodate in the available space between the feeds of the antenna elements and cause additional losses. A slow-wave structure according to FIG. 7B is particularly suitable for an application in S[hort]R[ange]R[adar] because such a slow-wave structure is particularly broadband (see page 410 in S. K. Koul, B. Bhat, “Microwave and Millimeter Wave Phase Shifters,” Vol. 1 and Vol. 2, Artech House, Boston, London, 1991).
(iii) Changing the width of a beam lobe emitted by a phase symmetrically fed antenna (see FIG. 2C) by delaying the signals of the external antenna elements by mechanically controlled slow-wave phase shifters:
   For all phase shifters the same mechanical influence may be used, e.g., by moving a dielectric sheet up or down over the feed network containing the slow-wave phase shifters. Thus only a mechanical actuator and/or a manipulated variable is necessary.

The exemplary embodiment and/or exemplary method of the present invention also relates to a beam device for emitting and/or receiving electromagnetic radiation, in particular electromagnetic HF radar radiation, having at least one device designed in particular as a mechanical slow-wave phase shifter and/or in particular as a mechanical stub-loaded line phase shifter of the type defined above.

Finally, the exemplary embodiment and/or exemplary method of the present invention relates to the use of at least one device of the type defined above and/or a beam device of the type defined above and/or a method of the type defined above in the automotive field, in particular in the field of automotive environment sensors, e.g., for measuring and determining the angular position of at least one object that would also be relevant in precrash sensing for deployment of an airbag in a motor vehicle, for example.

A sensor system, in particular a radar sensor system, ascertains whether a collision with the object detected, e.g., another motor vehicle, is imminent or possible. If a collision occurs, sensors also determine at which speed and at which point of impact the collision occurs.

With a knowledge of this information, lifesaving milliseconds may be gained for the driver of the vehicle, during which preparatory measures may be taken, e.g., in triggering the airbag or in tightening the belt system.

Other areas for use of the exemplary device and the exemplary method according to the present invention include parking assistance systems, dead angle detection and/or dead angle monitoring or a stop-and-go system as an expansion of an existing device for adaptive automatic regulation of driving speed such as an A[daptive]C[ruise]C[ontrol] system (=system for adaptive regulation of speed).

Consequently, the mechanical phase shifter system proposed according to the exemplary embodiment and/or exemplary method of the present invention having a planar slow-wave structure may be used in the L[ong]R[ange]R[adar] range as well as in ACC systems, e.g., those of the third generation, as well as in the SRR range.

In this context, LRR is generally understood to refer to a long-range radar for long-range functions, typically being used at a frequency of 77 GHz for ACC functions.

In principle the SRR system may be equipped with the planar slow-wave structure proposed according to the exemplary embodiment and/or exemplary method of the present invention and/or with the stub-loaded line structure which is also a type of slow-wave structure and is proposed according to the exemplary embodiment and/or exemplary method of the present invention if targeted adjustment of an elevation angle proves to be necessary, for example.

This is true to an even greater extent for subsequent generations of SRR if
greater beam bundling is to be performed at the receiving end in particular in conjunction with an increase in range or
larger antenna arrays are used at the transmitting end in particular, thus also having greater beam bundling, to further reduce secondary lobes.

In this context, SRR is generally understood to refer to a short-range radar for short-range functions, typically being used at a frequency of 24 GHz for parking assistance functions or for precrash functions for deployment of an airbag.

Not least of all for this purpose, the structure according to the exemplary embodiment and/or exemplary method of the present invention may be used in an SRR sensor with which the direction of the beam lobe in elevation is adjusted by at least one vehicle-specific dielectric and/or conductive cap. Finally, there are many applications in the civilian and military fields in the RA[dio]D[etecting]A[nd]R[anging] field and in the communications field (see N. Fourikis, “Advanced Array Systems, Applications and RF Technologies,” Academic Press, San Diego, 2001).

### BRIEF DESCRIPTION OF THE DRAWINGS

FIG. 1A shows in a partially schematic diagram a first arrangement having parallel feed according to the related art for triggering via phase shifters a phase-controlled group antenna having a one-dimensionally pivotable beam lobe.

FIG. 1B shows a partially schematic diagram of a second arrangement having parallel feed according to the related art for triggering via phase shifters a phase-controlled group antenna having a one-dimensionally pivotable beam lobe, rows of multiple series-fed antenna elements forming the group antenna being situated in the second dimension.

FIG. 2A shows a schematic diagram of a first embodiment for a feed to antenna elements in the form of a series feed according to the related art.

FIG. 2B shows a schematic diagram of a second embodiment for a feed to antenna elements in the form of a corporate feed according to the related art.

FIG. 2C shows a schematic diagram of a third embodiment for a feed to antenna elements in the form of a phase-symmetrical and amplitude-symmetrical feed according to the related art.

FIG. 3A shows a partially schematic diagram of a series-fed third arrangement according to the related art for triggering via phase shifters a phase-controlled group antenna having a one-dimensionally pivotable beam lobe.

FIG. 3B shows a partially schematic diagram of a series-fed fourth arrangement according to the related art for triggering via phase shifters a phase-controlled group antenna having a one-dimensionally pivotable beam lobe, rows of multiple series-fed antenna elements forming the group antenna being situated in the second dimension.

FIG. 4A shows a cross-sectional diagram (top part of the figure) and a view from above (bottom part of the figure) of a first device according to the related art in which the planar line arrangement is arranged as a coplanar line.

FIG. 4B shows a cross-sectional diagram (top part of the figure) and a view from above (bottom part of the figure) of a second device according to the related art in which the planar line arrangement is arranged as a microstrip line.

FIG. 4C shows a cross-sectional diagram (top part of the figure) and a view from above (bottom part of the figure) of a third device according to the related art in which the planar line arrangement is arranged as a slot line.

FIG. 5 shows a perspective diagram of a fourth device according to the related art (see WO 00/54368 A1) in the form of a scanning antenna having mechanically controllable phase shifting by dielectric loading of a dielectric waveguide having a metallic element.

FIG. 6A shows a cross-sectional diagram (top part of the figure) and a view from above (bottom part of the figure) of a fifth device according to the related art in which the planar line arrangement is designed as a coplanar line having alternating line sections of a high impedance and line sections of a low impedance.

FIG. 6B shows a cross-sectional diagram (top part of the figure) and a view from above (bottom part of the figure) of a sixth device according to the related art in which the planar line arrangement is designed as a microstrip line having short no-load stubs that generate an additional capacitance per unit length.

FIG. 7A shows a schematic diagram of a first arrangement of a stub-loaded line phase shifter according to the related art.

FIG. 7B shows a schematic diagram of a second arrangement of a stub-loaded line phase shifter according to the related art.

FIG. 8A shows a perspective diagram of a first exemplary device according to the present invention, a variation of the distance of a dielectric sheet (or conductive sheet, in particular of metal) from the microwave substrate and/or a lateral change in position of the dielectric sheet (or conductive sheet, in particular of metal) with respect to the microwave substrate being provided.

FIG. 8B shows a perspective diagram of a second exemplary device according to the present invention, a variation of the distance of a dielectric sheet (or conductive sheet, in particular of metal) from the microwave substrate and/or a lateral change in position of the dielectric sheet (or conductive sheet, in particular of metal) with respect to the microwave substrate being provided.

FIG. 9A shows a schematic diagram of a basic diagram of the exemplary method according to the present invention by which the phase shift of a mechanical slow-wave phase shifter having generic TEM lines is derivable in a first phase state (<--> cover layer creates a first effective dielectric constant ∈₁).

FIG. 9B shows a schematic diagram of a basic diagram of the exemplary method according to the present invention by which the phase shift of a mechanical slow-wave phase shifter having generic TEM lines is derivable in a second phase state (<--> altered cover layer creates a second effective dielectric constant ∈₂ and influences the line impedances).

FIG. 10A shows a schematic diagram of an A[dvanced] D[esign] S[ystem] simulation model according to the present invention.

FIG. 10B shows a two-dimensional graphic plot of the simulation results of the ADS simulation model from FIG. 10A, measured in decibels and plotted as a function of the frequency measured in Gigahertz.

FIG. 10C shows a two-dimensional graphic plot of the phase-angle deviation according to the simulation results from FIG. 10B of the ADS simulation model from FIG. 10A, plotted as a function of the frequency measured in Gigahertz.

FIG. 11A shows a basic diagram of a third exemplary embodiment of the device according to the present invention designed as a mechanical stub-loaded line phase shifter in a first phase state (<--> cover layer creates a first effective dielectric constant ∈₁).

FIG. 11B shows a basic diagram of the device from FIG. 11A designed as a mechanical stub-loaded line phase shifter in a second phase state (<--> altered cover layer creates a second effective dielectric constant ∈₂ and influences the line impedances).

FIG. 12A shows a schematic diagram of an ADS simulation model according to the present invention for the mechanical stub-loaded line phase shifter from FIGS. 11A and 11B.

FIG. 12B shows a two-dimensional graphic plot of the simulation results of the ADS simulation model from FIG. 12A measured in decibels and plotted as a function of the frequency measured in Gigahertz.

FIG. 12C shows a two-dimensional graphic plot of the simulation results of the ADS simulation model from FIG. 12A measured in decibels, plotted as a function of the frequency measured in Gigahertz and provided to supplement FIG. 12B.

FIG. 12D shows a two-dimensional graphic plot of the phase-angle deviation according to the simulation results from FIG. 12B and FIG. 12C of the ADS simulation model from FIG. 12A, plotted as a function of the frequency measured in Gigahertz.

FIG. 13A shows a basic diagram of a fourth exemplary embodiment of the device according to the present invention designed as a mechanical stub-loaded line phase shifter in a first phase state (<--> cover layer creates a first effective dielectric constant ∈₁).

FIG. 13B shows a basic diagram of the device from FIG. 13A designed as a mechanical stub-loaded line phase shifter in a second phase state (<--> altered cover layer creates a second effective dielectric constant ∈₂ and influences the line impedances).

FIG. 14A shows a basic diagram of a fifth exemplary embodiment of the device according to the present invention designed as a mechanical stub-loaded line phase shifter in a first phase state (<--> cover layer creates a first effective dielectric constant ∈₁).

FIG. 14B shows a basic diagram of the device from FIG. 14A designed as a mechanical stub-loaded line phase shifter in a second phase state (<--> altered cover layer creates a second effective dielectric constant ∈₂ and influences the line impedances).

FIG. 15A shows a schematic diagram of an optimization model according to the present invention for the mechanical stub-loaded line phase shifter from FIGS. 14A and 14B.

FIG. 15B shows a two-dimensional graphic plot of the simulation results of the optimization model from FIG. 15A, measured in decibels and plotted as a function of the frequency measured in Gigahertz.

FIG. 15C shows a two-dimensional graphic plot of the simulation results of the optimization model from FIG. 15A measured in decibels, plotted as a function of the frequency measured in Gigahertz and provided to supplement FIG. 15B.

FIG. 15D shows a two-dimensional graphic plot of the phase-angle deviation according to the simulation results from FIGS. 15B and 15C of the optimization model from FIG. 15A, plotted as a function of the frequency measured in Gigahertz.

FIG. 15E shows a two-dimensional graphic plot of the phase error according to the simulation results from FIGS. 15B, 15C, and 15D of the optimization model from FIG. 15A, plotted as a function of the frequency measured in Gigahertz.

FIG. 16 shows a perspective diagram of an exemplary embodiment of a phase-controlled group antenna according to the present invention having mechanical slow-wave phase shifters according to the present invention situated between the antenna elements.

FIG. 17 shows a two-dimensional graphic plot (known as an antenna diagram in elevation) of the directivity in elevation for the simulation model from FIG. 16, measured in decibels and plotted as a function of the beam deflection angle measured in degrees, having a dielectric sheet at various distances (0 micrometer; 20 micrometers; 100 micrometers; 300 micrometers; 600 micrometers) from the feed network.

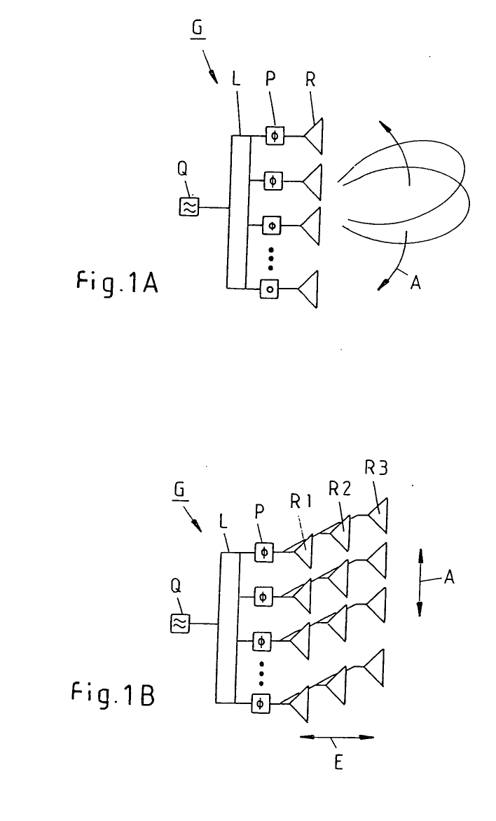

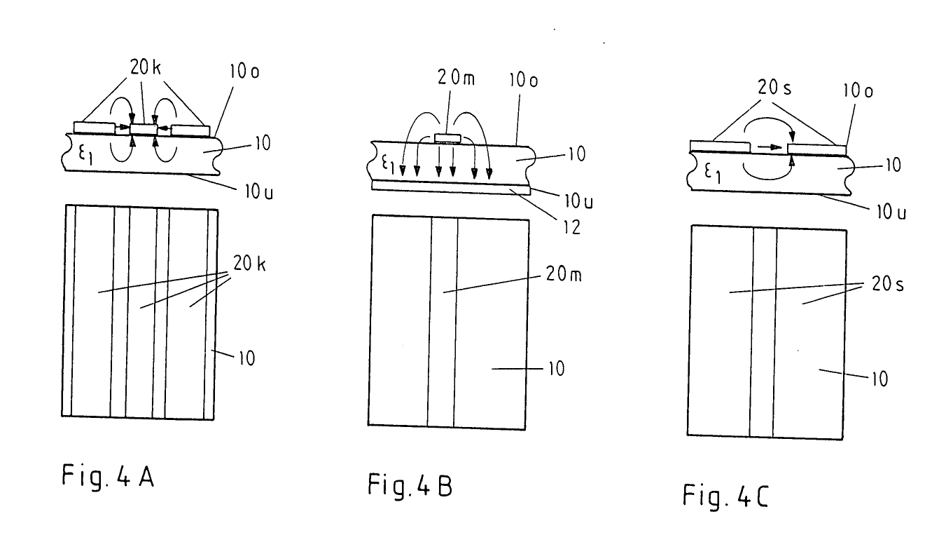

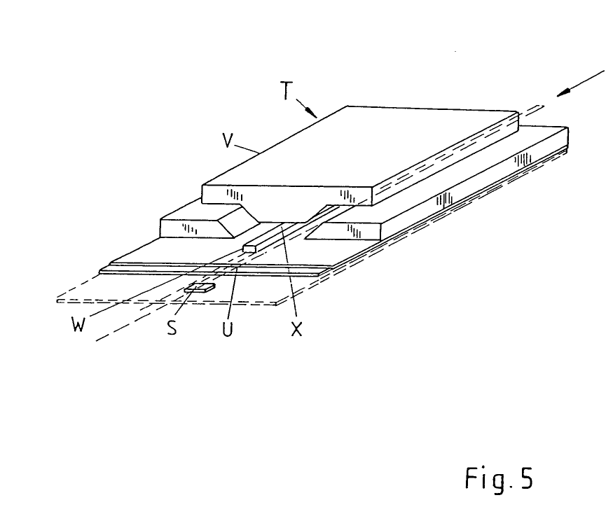

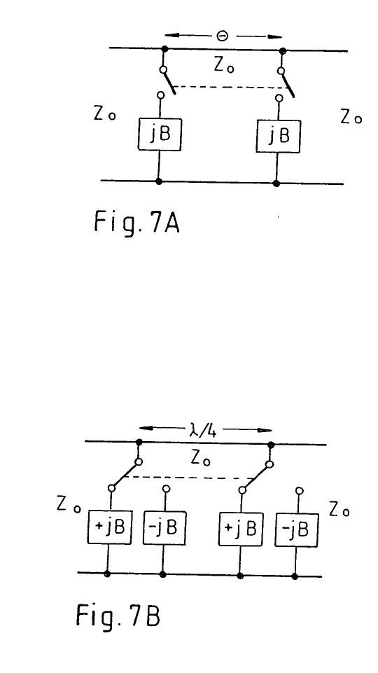

The same or similar embodiments, elements, or features are provided with identical reference notation in FIGS. 1A through 17.

### DETAILED DESCRIPTION

As an example, (radar) device 100 according to the present invention designed in particular for the short range and a method based on this device for acquiring, detecting, and/or analyzing one or more objects are explained. Essentially all combinations of the slow-wave principle and/or the stub-loaded line principle (which is also a type of slow-wave structure) with all the features of a mechanically controllable phase shifter may be provided.

In this context, device 100 which functions as a mechanical phase shifter having a planar slow-wave structure may be used in the manner essential to the exemplary embodiment and/or exemplary method of the present invention for sending and/or receiving electromagnetic HF radar radiation.

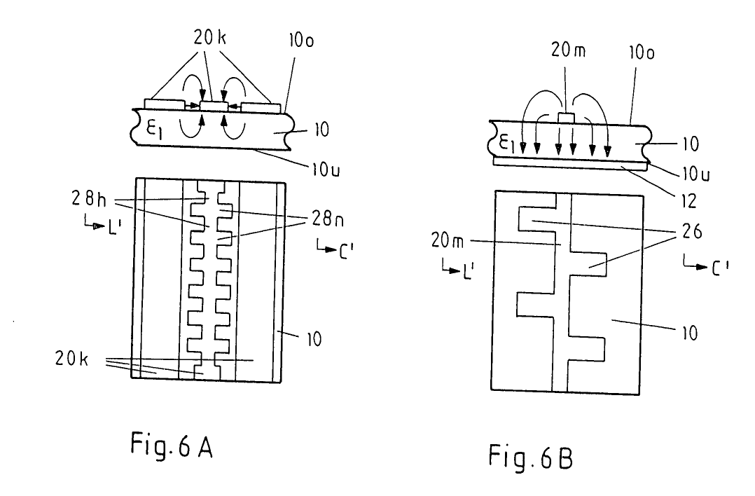

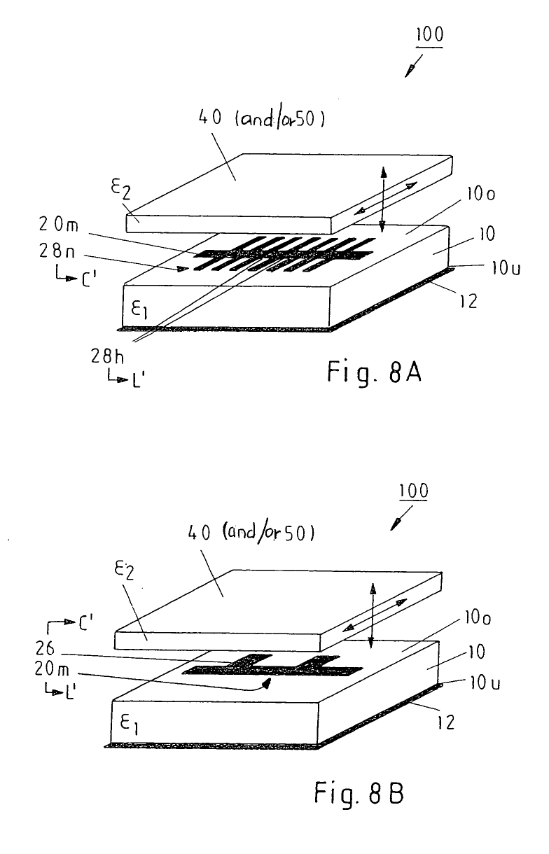

Device 100 therefore has a substrate layer, specifically a microwave substrate 10, having a dielectric constant ∈₁. A metallic coating layer 12 is applied to bottom side 10u of substrate 10 (see FIG. 6B: embodiment according to the related art; see FIG. 8A: first exemplary embodiment of present device 100; see FIG. 8B: second exemplary embodiment of present device 100).

A planar feed network in the form of one or more lines 20m runs on top side 10o of substrate 10. A microstrip line 20m is depicted as an example in FIG. 6A (=embodiment according to the related art), in FIG. 8A (=first exemplary embodiment of a mechanical phase shifter 100 having a planar slow-wave structure according to the present invention), and in FIG. 8B (=second exemplary embodiment of a mechanical phase shifter 100 having a planar slow-wave structure according to the present invention).

The line (=microstrip line 20m) according to FIG. 8A here has short line segments 28h, 28n having alternating high and low impedance, the particular length of line segments 28h, 28n being smaller than the line wavelength. A line segment 28h of a high impedance creates mainly effective (longitudinal) inductance L′ per unit length; a line segment 28n having a low impedance creates mainly effective (transverse) capacitance C′ per unit length.

This is shown in FIG. 8A where this planar slow-wave structure is shown in microstrip technology with alternating sections 28h of high line impedance and sections 28n of low line impedance.

According to FIG. 8B, (longitudinal) inductance L′ per unit length is created by the classical line (=microstrip line 20m) and (transverse) capacitance per unit length C′ is increased by stubs 26 going out from this planar line 20m and/or by discrete capacitors at periodic mutual distances, these distances being smaller than the wavelength. To create required line impedance Z, classical line 20 is usually to be designed with a high resistance, i.e., to be more inductive than the required line impedance.

This is illustrated in FIG. 8B where this planar slow-wave structure is depicted in the form of a stub-loaded line phase shifter in microstrip technology.

The transition between the principle according to FIG. 8A and the principle according to FIG. 8B is fluid and is determined less by physical factors (a short broadened line segment 28n may also be interpreted as a short broad stub 26), but in particular is determined by the more convenient argumentation and computation for the particular geometry.

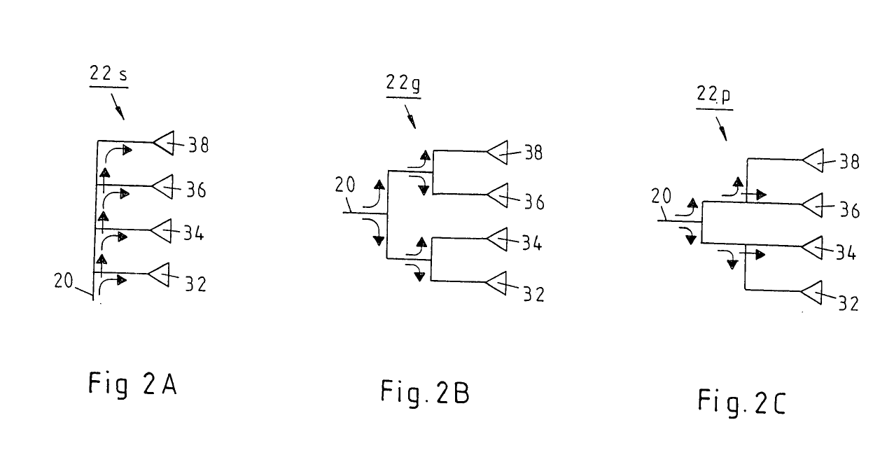

Planar line 20 may lead to multiple antenna elements or beam (emitter) elements 32, 34, 36, 38 (see FIGS. 2A, 2B, 2C: embodiments according to the related art) which are also applied to HF board 10 in the form of a substrate (and not shown explicitly in FIG. 8A or in FIG. 8B for reasons of simplicity of the diagram).

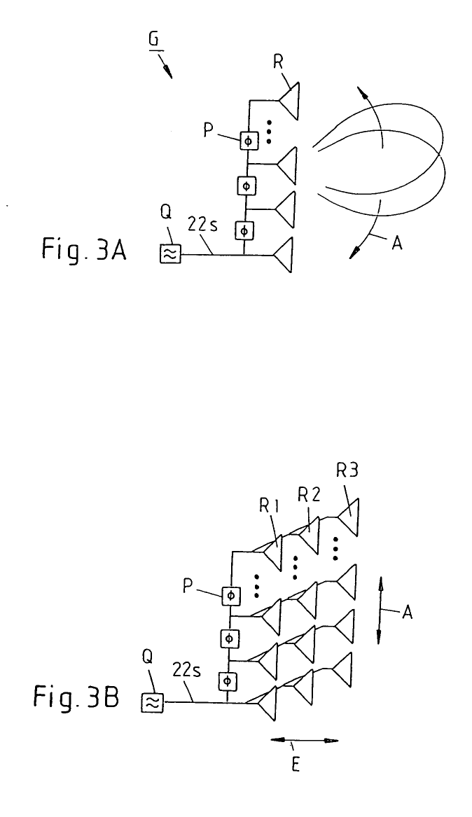

Feed to these beam emitter elements 32, 34, 36, 38 may be accomplished in various ways, e.g., as a series feed 22s (see FIGS. 2A, 3A, 3B: embodiments according to the related art). In such a series feed 22s there is a direct or capacitive link of the feed network to top side 10o of substrate 10.

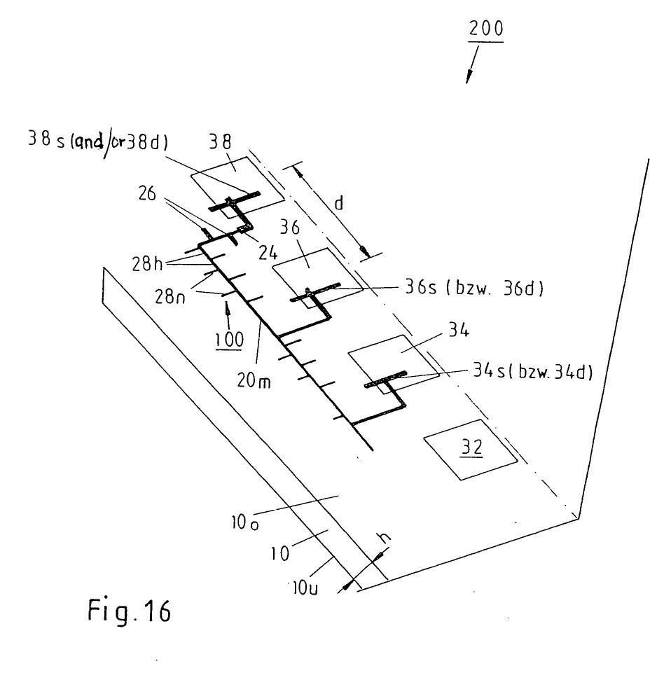

As an alternative to such a direct or capacitive link of the feed network to top side 10o of substrate 10, there may also be a series feed 22s from bottom side 10u of substrate 10 by electromagnetic coupling of the feed network through one slot 32s, 34s, 36s, 38s each (see FIG. 16).

As an alternative to such an electromagnetic coupling of the feed network from bottom side 10u of substrate 10, there may also be a series feed 22s from bottom side 10u of substrate 10 via one electric bushing 32d, 34d, 36d, 38d each.

A method for supplying feed to antenna elements 32, 34, 36, 38 as an alternative or supplement to the method for series feed 22s is corporate feed 22g (see FIG. 2B: embodiments according to the related art).

Another method for supplying feed to antenna elements 32, 34, 36, 38 as an alternative or supplement to the method for series feed 22s and/or the method for corporate feed 22g is phase-symmetrical and amplitude-symmetrical feed 22p (see FIG. 2C: embodiments according to the related art).

As indicated by the diagram according to FIG. 8A (=first exemplary embodiment) and the diagram according to FIG. 8B (=second exemplary embodiment), the beam angle may also be set now according to the exemplary embodiment and/or exemplary method of the present invention in elevation E of device 100 provided for a motor vehicle by tuning planar HF signal line 20 in a controlled and deliberate manner.

This intentional and deliberate tuning of planar HF signal line 20 and thus the intentional and deliberate influence on phase difference Δφ between antenna elements 32, 34, 36, 38 and the resulting antenna diagram are accomplished by varying effective dielectric constant ∈_{eff}, i.e., the propagation coefficient of signal line 20 (called “dielectric loading”) in the first exemplary embodiment of the present invention according to FIG. 8A and also in the second exemplary embodiment of the present invention according to FIG. 8B.

To do so,
the distance of a cap or sheet of dielectric material 40 having a dielectric constant ∈₂>1 above planar signal line 20 may be varied (=change in position of the dielectric cap or sheet in the vertical direction) and/or
the relative position of the cap or sheet of dielectric material 40 with respect to microwave substrate 10 may be varied laterally (=change in position of the dielectric cap or sheet in the horizontal direction).

As a result by increasing dielectric constant ∈₂ of dielectric material 40 above line 20, the propagation coefficient on line 20 and thus phase difference Δφ between two beam emitter elements 32, 34 and/or 34, 36 and/or 36, 38 may be increased.

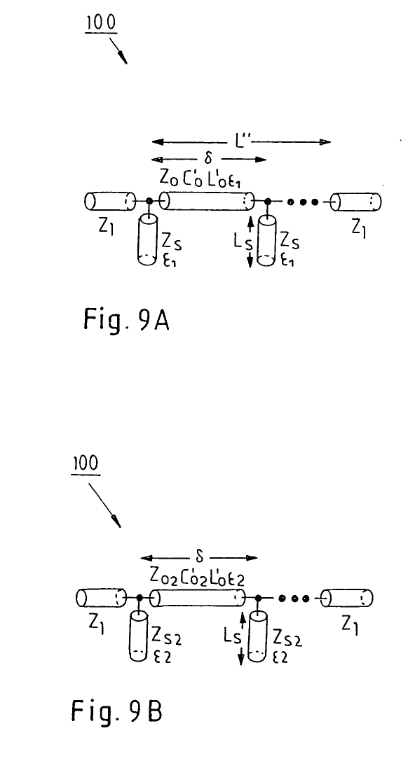

Since the exemplary embodiment and/or exemplary method of the present invention includes a phase shifter 100 having a distributed slow-wave structure and generic planar TEM lines, the function principle of the slow-wave phase shifter is explained in greater detail below on the basis of a design having generic planar TEM lines according to FIG. 9A and according to FIG. 9B and various alternatives of the arrangement according to the present invention are described.

A large number of stubs with terminal no load are provided at a distance δ=d/λ₀ where λ₀<<λ on a line having impedance Z₀ which is greater than system impedance Z₁, forming a distributed slow-wave structure. The total length of the phase shifter is L″.

The following equations should hold for these lines
∈₁=0.5·(∈_{r,substrate}+∈_{r,coverlayer1}) and β₁=ω·(L₀′·C₀′)^{1/2}=ω·(μ₀·∈₀·∈₁)^{1/2},
∈₂=0.5·(∈_{r,substrate}+∈_{r,coverlayer2}) and β₂=ω·(L₀′·C₀₂′)^{1/2}=ω·(μ₀·∈₀·∈₂)^{1/2}.

The impedance and length of the stubs are set so that in the first phase state (=without a cover layer or with a cover layer of a first material and/or with a cover layer in a first position) resulting line impedance Z₀ is equal to system line impedance Z₁. A finite distance from the cover layer and/or the multiple layers of the cover layer is to be taken into account here, if necessary, in the form of an effective dielectric constant ∈_{r,coverlayer}.

The susceptances of the stubs are taken into account simply as additional capacitance Cₛ₁′ per unit length in this connection, thus yielding in the first phase state −Z₀=(L₀′/C₀′)^{1/2} for the resulting line impedance and −Z₁=[L₀′/(C₀′+Cₛ₁′)]^{1/2} for the system line impedance, where Cₛ₁′=(μ₀·∈₀)^{1/2}·(2π·Z_{X} δ)⁻¹·tan(β₁·L_{S}) and ∈_{eff,1}=ω·[L₀′·(C₀′+Cₛ₁′)]^{1/2}.

In the second phase state (with a cover layer of a second material and/or with a cover layer in a second position so that second effective dielectric constant ∈₂ is greater than first effective dielectric constant ∈₁), this yields Z₂=[L₀′/(C₀₂′+Cₛ₂′)]^{1/2} for the system line impedance, where
Cₛ₂′=(μ₀·∈₀)^{1/2}·(2π·Z_{S2}·δ)⁻¹·tan(β₂·L_{S}),
β_{eff,2}=ω[L₀′·(C₀₂′+Cₛ₂)]^{1/2},
C₀₂′=C₀′·∈₂/∈₁ and
Z_{S2}=Z_{S}·(∈₁/∈₂)^{1/2}.

It is assumed that inductance L₀′ per unit length of the line does not change as a function of the cover layer. Capacitance C₀′ per unit length is proportional to the effective dielectric constant.

For phase-angle deviation Δφ based on length L″ of the phase shifter, this yields

$$\frac{Δ φ}{{L}^{″}} = {β}_{eff , 2} - {β}_{eff , 1} = \frac{2 π}{{λ}_{0}} [ \sqrt{{ɛ}_{2} + \frac{{Z}_{0} \sqrt{{ɛ}_{2}}}{2 π {Z}_{s} δ} tan {β}_{2} {L}_{s}} - \sqrt{{ɛ}_{1} + \frac{{Z}_{0} \sqrt{{ɛ}_{1}}}{2 π {Z}_{s} δ} tan {β}_{1} {L}_{s}} ]$$

and for change Z₂/Z₁ in the line impedance:

$$\frac{{Z}_{2}}{{Z}_{1}} = \sqrt{[ {ɛ}_{1} + \frac{{Z}_{0} \sqrt{{ɛ}_{1}}}{2 π {Z}_{s} δ} tan {β}_{1} {L}_{s} ] / [ {ɛ}_{2} + \frac{{Z}_{0} \sqrt{{ɛ}_{2}}}{2 π {Z}_{s} δ} tan {β}_{2} {L}_{s} ]}$$

In a comparison of phase-angle deviation Δφ/L″ of the phase shifter with the relationship given at the beginning Δφ/L=(2π/λ₀)·(∈₂^{1/2}−∈₁^{1/2}) for the principle of dielectric loading, it may be concluded that much larger values are achievable with the phase shifter if tangent function tan is in the nonlinear range, so argument β₂·L_{S} should be approximately in the range π/4<β₂·L_{S}<π/2.

In the linear range of the tangent function, where tan(x) is approximately equal to x, there is no advantage with phase-angle deviation Δφ per length of the phase shifter in comparison with phase-angle deviation Δφ per length in dielectric loading. The increase in the phase-angle deviation is associated with an increase in the change in line impedance.

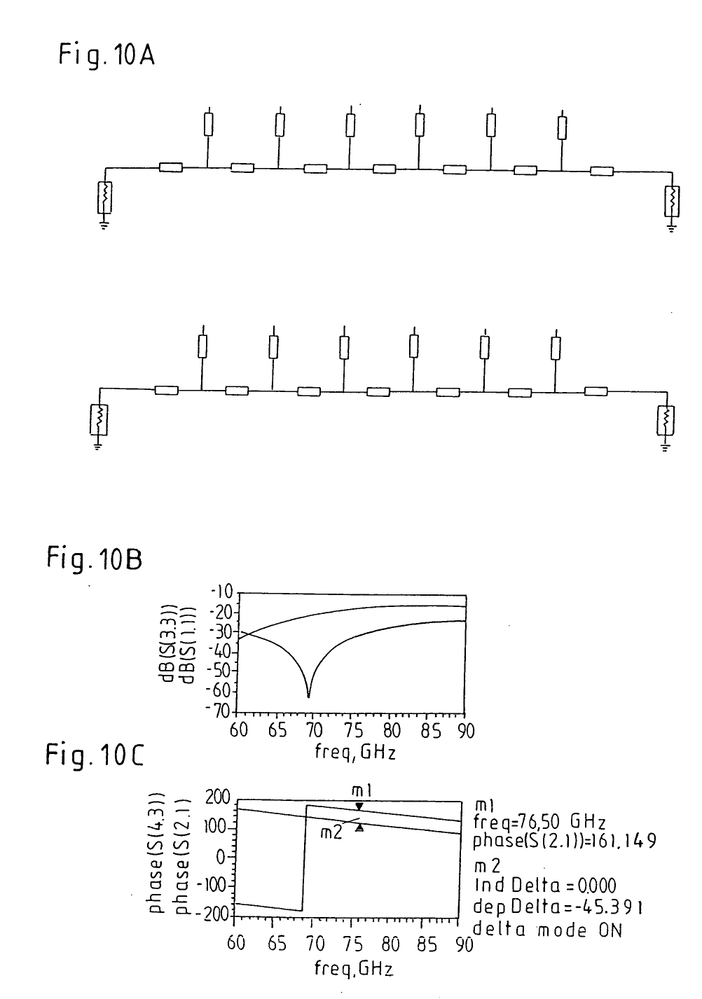

FIG. 10A shows an ADS model. FIG. 10B shows simulation results of the distributed slow-wave phase shifter for a phase shift of 45° at 76.5 Gigahertz. Ro3003 having a dielectric constant ∈=3 is assumed as the substrate material and as the cover layer.

In the derivation of equations for FIGS. 9A and 9B explained above, it is assumed that the cover layer covers the entire structure, i.e., also line L″ running longitudinally whose impedance Z₀ and whose propagation coefficient β₁ change according to impedance Z₀₂ and/or propagation coefficient β₂. Likewise, however, structures in which only the stubs are influenced by the cover layer may also be provided.

If the structures which influence propagation coefficient β, e.g., the stubs, cause small enough changes in capacitance C′ per unit length and are located at a sufficiently small distance, then very broadband phase shifters are feasible.

The stubs in the structure according to FIG. 10A are such a great distance apart that the assumption that the stubs may be taken into account simply as a change in capacitance C′ per unit length is only somewhat justified and the adaptation of the structure fails to achieve the values which are theoretically achievable. To do so, the distance between the stubs must be further reduced. However, the limits of feasibility are reached here when the required width of the conductor does not allow a small enough distance.

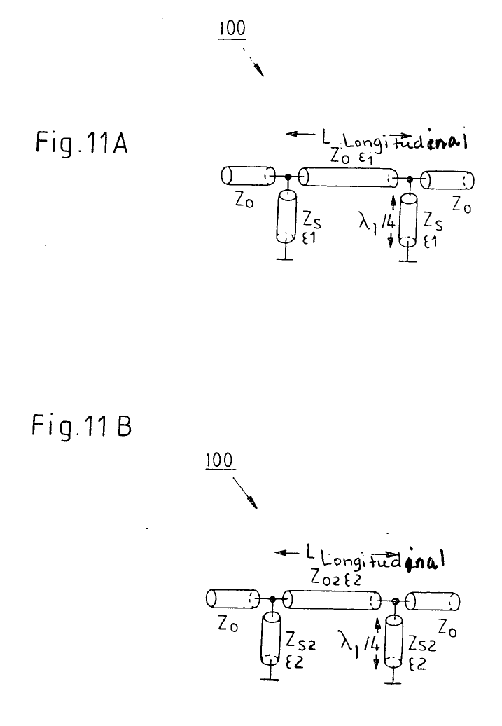

In the design of a third exemplary embodiment of a device 100 according to the present invention (=first exemplary embodiment of a mechanical phase shifter 100 having a stub-loaded line structure; see FIG. 11A and FIG. 11B: switching the reactances to the line for a second phase state, i.e., switching two susceptances jB at a distance θ), there are two short-circuit stubs at a mutual distance L_{longitudinal} on a line of impedance Z₀ which is equal to system line impedance Z₁. In principle, no-load lines (called no-load stubs) or combinations of stubs with discrete elements could also be used.

The length of the stubs amounts to one fourth of line wavelength λ₁ for the first phase state (=without a cover layer or with a cover layer of a first material and/or with a cover layer in a first position) so that the signal on the line is not influenced by the stubs in the first phase state.

In the second phase state (with a cover layer of a second material and/or with a cover layer in a second position so that second effective dielectric constant ∈₂ is greater than first effective dielectric constant ∈₁) the effective length of the stubs is shortened and their electric distance is shortened. Now the adaptation and the phase-angle deviation of mechanical phase shifter 100 may be optimized via impedance Z_{S2} of the stubs and the distance between the stubs.

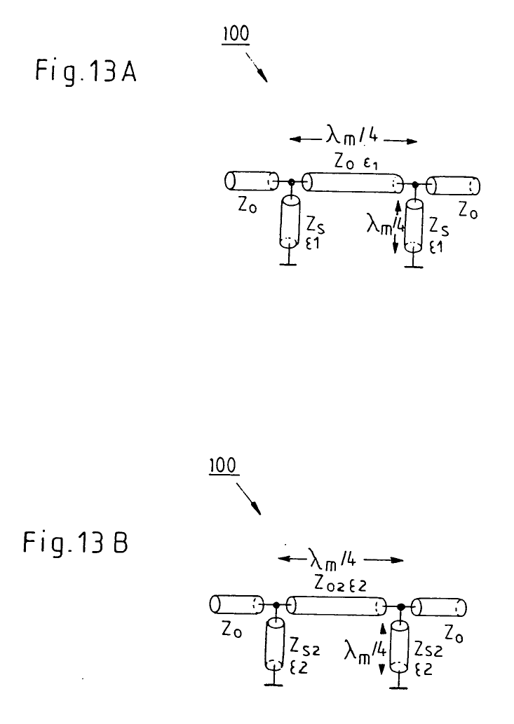

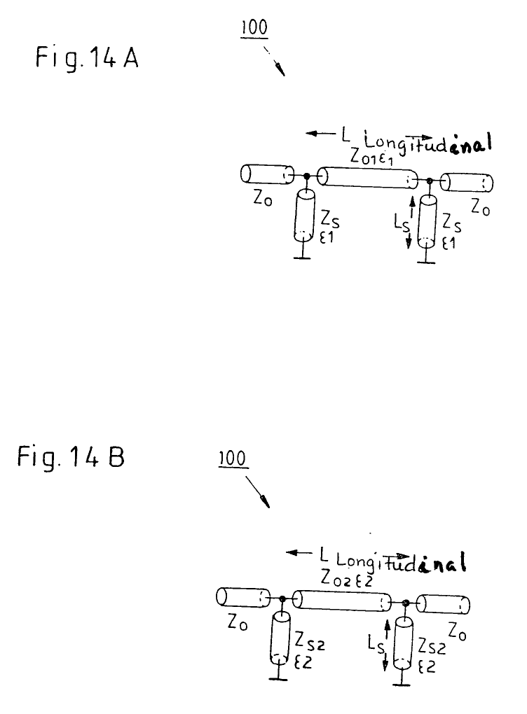

Additional degrees of freedom include the dielectric constant and the distance from the cover layer (in FIG. 11A, in FIG. 11B, in FIG. 13A, in FIG. 13B, in FIG. 14A, and in FIG. 14B it is always assumed that the cover layer covers the entire structure of mechanical phase shifter 100; however, structures in which only the stubs are influenced by the cover layer may also be used).

Now to follow the derivation in S. K. Koul, B. Bhat, “Microwave and Millimeter Wave Phase Shifters,” Vol. 1 and Vol. 2, Artech House, Boston, London, 1991, pages 408 ff, and if, in calculating S₂₁ from the chain matrices, the fact that the impedance of the longitudinal line changes with the cover layer in Z₀₂ is taken into account, this yields the following equation after a lengthy calculation for the distance between the stubs:

$$\begin{matrix}{θ}_{1} = {β}_{2} {L}_{longitudinal} \\ = - arctan \{ \frac{2 {Z}_{0}^{2} {Z}_{02} B ( {Z}_{0}^{2} - {Z}_{02}^{2} - {Z}_{0}^{2} {Z}_{02}^{2} {B}^{2} )}{{Z}_{0}^{2} {Z}_{02}^{2} {B}^{2} ( 2 {Z}_{02} + {Z}_{0}^{2} {Z}_{02}^{2} {B}^{2} - 2 {Z}_{0}^{2} ) + {( {Z}_{02}^{2} - {Z}_{0}^{2} )}^{2}} \}\end{matrix}$$

The phase in the first phase state is given by −β₁·L_{longitudinal}. For the phase in the second phase state, the following is obtained:

$$\begin{matrix}{θ}_{2} = arg {S}_{21} \\ = \{ \begin{matrix}φ & φ < 0 \\ - 180 ° + φ & φ > 0\end{matrix} with φ \\ = - arctan \{ \frac{tan {θ}_{1} ( {Z}_{0}^{2} - {Z}_{02}^{2} - {Z}_{0}^{2} {Z}_{02}^{2} {B}^{2} ) + 2 {Z}_{0}^{2} {Z}_{02} B}{2 {Z}_{0} {Z}_{02} ( 1 - {Z}_{02} ( 1 - {Z}_{02} B tan {θ}_{1} )} \} .\end{matrix}$$

The phase shift is thus obtained as:
Δφ=θ₂+β₁·L_{longitudinal}.

In the presence of the cover layer, the stubs are described by their susceptance jB at the stub input. For a short-circuit stub and for the dependence of the line impedances on the dielectric constant, jB=−Z_{S2}⁻¹·cot(β₂·L_{S})

where

Z_{S2}=Z_{S}·(∈₁/∈₂)^{1/2} and
Z₀₂=Z₀·(∈₁/∈₂)/^{1/2}.

Again the following equations hold for the lines:
∈₁=0.5·(∈_{r,substrate}+∈_{r,coverlayer1}) and
β₁=ω·(L₀′·C₀′)^{1/2}=ω·(μ₀·∈₀·∈₁)^{1/2},
∈₂=0.5·(∈_{r,substrate}+∈_{r,coverlayer2}) and
β₂=ω·(L₀′·C₀₂′)^{1/2}=ω·(μ₀·∈₀·∈₂)^{1/2}.

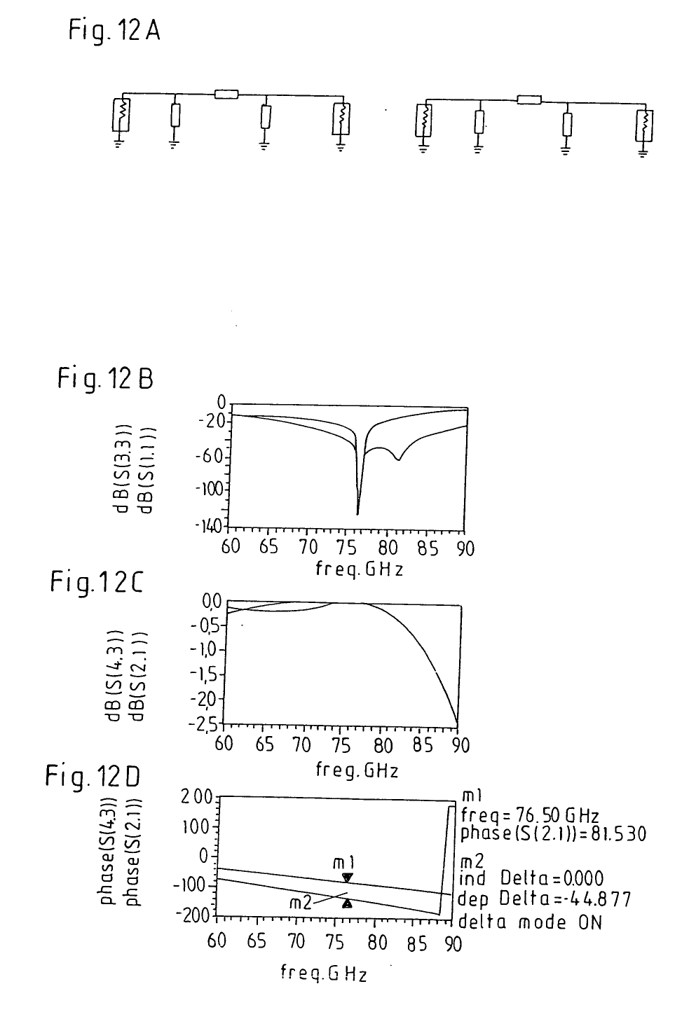

Degrees of freedom for adjusting the phase shift include impedance Z_{S} of the stubs and second effective dielectric constant ∈₂. The structure is ideally adapted in both phase states. The signal phase changes in good approximation in proportion to second effective dielectric constant ∈₂. An exemplary embodiment of a mechanical phase shifter 100 by 45° with the same boundary conditions as in FIGS. 10A, 10B, and 10C is shown in FIGS. 12A, 12B, and 12C. The adaptation is ideal at 76.5 Gigahertz.

The fourth exemplary embodiment of a device 100 according to the present invention (=second exemplary embodiment of a mechanical phase shifter 100 with stub-loaded line structure) is shown in FIG. 13A and in FIG. 13B (switching between reactances of the same absolute value having different signs for the two phase states, i.e., switching between susceptances +jB and −jB at an interval of λ/4).

A mean line wavelength λₘ (=line wavelength λₘ for a mean dielectric constant) is calculated from the two effective dielectric constants of the first phase state and the second phase state.

The length of the stubs and the distance between the stubs in relation to one another are set at λₘ/4, i.e., at one fourth of mean line wavelength λₘ. Thus the stubs are transformed for one dielectric constant into a positive susceptance and for the other dielectric constant into a negative susceptance. In both cases, the distance between the stubs in relation to one another is as close as possible to one fourth of the line wavelength.

For the setting of the phase shift, impedance Z_{S} of the stubs and second effective dielectric constant ∈₂ remain as degrees of freedom. The adaptation of the structure is more difficult than in the first exemplary embodiment of a mechanical phase shifter 100 having a stub-loaded line structure (see FIG. 11A and FIG. 11B) and it is not as easy to achieve large phase shifts. Typical phase shifts of 22.5°, for example, are achievable under practical conditions.

The principle of a fifth exemplary embodiment of a device 100 according to the present invention (=third exemplary embodiment of a mechanical phase shifter 100 having a general stub-loaded line structure) is shown in FIG. 14A and in FIG. 14B.

In contrast with the present structure according to FIGS. 11A and 11B and in contrast with the present structure according to FIGS. 13A and 13B, no specifications are given for the lengths of the stubs or for the distances between the stubs in relation to one another.

Susceptances jB₁ and jB₂ are not necessarily equal in value and also need not have different signs. The design of this general mechanical stub-loaded line phase shifter is optimizable with the help of simulation programs which include, for example, routines for nonlinear optimization of
distance L_{longitudinal} between the stubs in relation to one another,
length L_{S} of the stubs,
line impedance Z₀₁ and
impedance Z_{S} of the stubs
   in ADS, for example.

Degrees of freedom include impedance Z_{S} of the stubs, length L_{S} of the stubs, line impedance Z₀, distance L_{longitudinal} between the stubs in relation to one another and second effective dielectric constant ∈₂. By aligning such structures in a row, broadband mechanical phase shifters having large phase shifts are achievable.

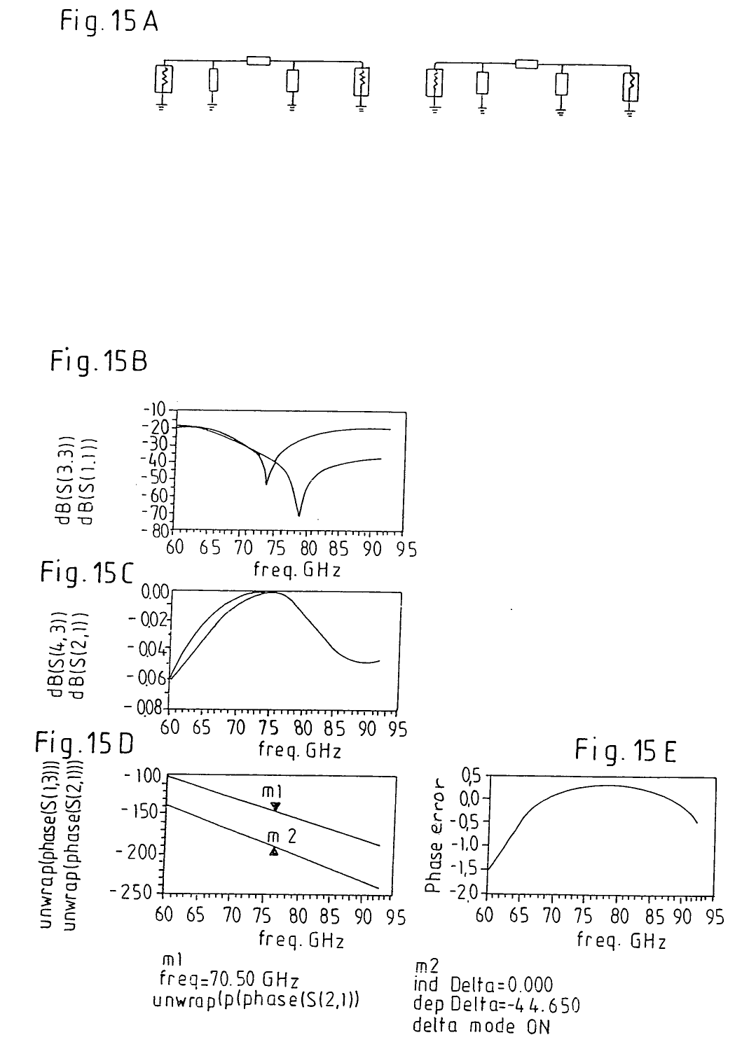

An exemplary simulation result for a mechanical phase shifter by 45° is illustrated in FIG. 15A and in FIGS. 15B, 15C, 15D, and 15E. The good true-time delay behavior over a wide frequency range is noteworthy.

Mechanical phase shifters 100 having slow-wave structures according to the present invention are also suitable in particular for influencing the phase-angle deviation and/or the phase shift between the electromagnetic radiation emitted and/or received by various antenna elements 32, 34, 36, 38 and/or the angle, in particular the elevation angle, of the emission and/or reception of the electromagnetic radiation and thus the antenna diagram of a radar antenna by a dielectric cap 40 via the feed network or by a dielectric Radom.

FIG. 16 shows a simulation model of a beam device 200 for emission and reception of electromagnetic radiation, namely electromagnetic HF radar radiation.

This beam device 200 is arranged as a 24 Gigahertz antenna having four patch elements 32, 34, 36, 38 (=antenna elements or beam emitter elements at a mutual distance a) coupled via one slot 32s, 34s, 36s, 38s each in substrate 10, these patch elements being applied in planar form together with microstrip line 20m to substrate 10 of thickness h.

Between antenna elements or beam (emitter) elements 32, 34, 36, 38 are mechanical slow-wave phase shifters 100 in the form of the device according to the present invention, in a manner essential to the exemplary embodiment and/or exemplary method of the present invention, formed by
line sections 24 going out from microstrip line 20m, e.g., no-load line sections or line sections short-circuited at their particular ends, for example,
stubs 26 going out from microstrip line 20m,
alternating
   line segments 28h of a high impedance corresponding to an effective inductance L′ per unit length, e.g., an effective longitudinal inductance per unit length and
   line segments 28n of a low impedance corresponding to an effective capacitance C′ per unit length, e.g., an effective transverse capacitance per unit length,
discrete elements, e.g., by inductors, capacitors or inductive and/or capacitive line bridges,
discrete serial and/or parallel reactances and
discrete serial and/or parallel susceptances (→ symbol jB).

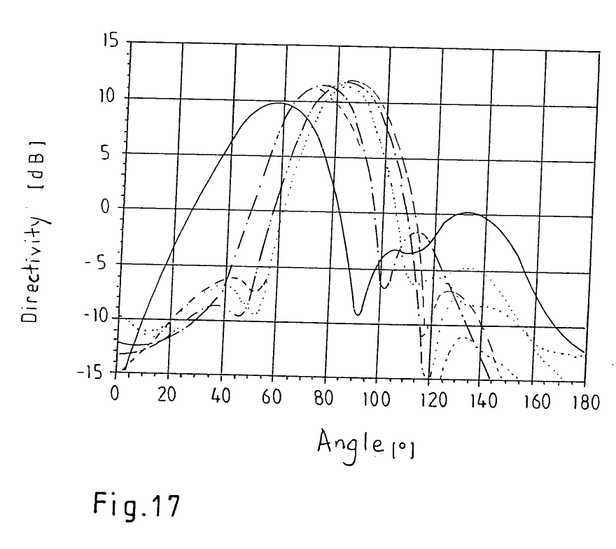

FIG. 17 shows simulation results for the antenna diagram in elevation with respect to beam device 200 from FIG. 16. The parameter is the distance of a dielectric cap 40 having effective dielectric constant ∈=3 over substrate 10. The metallic coating is assumed to be infinitely thin.

It is particularly noteworthy about these results that a beam pivoting by 30° (corresponding to a phase shift of approximately 90° between patch elements 32, 34, 36, 38) is achievable, the length of slow-wave phase shifter 100 being limited to the available distance of approximately 6.5 millimeters, corresponding approximately to λ/2 between antenna elements 32, 34, 36, 38.

Thus in summary it may be concluded that mechanical phase shifter 100 having a slow-wave structure according to the present invention which is provided for the adjustment of a certain phase shift Δφ is characterized by a significantly reduced length in comparison with the mechanical phase shifters from the related art as discussed in the beginning, which then promotes the goal of miniaturization of the corresponding components and parts.

The present structure according to the present invention is without a doubt identifiable, i.e., verifiable on the basis of the components
slow-wave structure, for example
   in the form of a line having alternating cross sections or
   in the form of a line having a stub-loaded line structure and/or
mechanical adjustment or setting, e.g.,
   by at least one motor-drive dielectric or metallic element, in particular a sheet via the slow-wave structure or
   by at least one cap and/or at least one Radom via the slow-wave structure.

1. A device for providing phase shifting on at least one single-layer or multilayer substrate to which is applied at least one planar line, the device comprising:
an arrangement to adjust the phase shift by varying an effective dielectric constant of the line, the arrangement including at least one of:
line sections going out from the line, and
stubs going out from the line, and
alternating line segments of a high impedance and line segments of a low impedance, and
one of: (i) discrete elements, including at least one of inductors and capacitors, or (ii) at least one of inductive line bridges and capacitive line bridges, and
at least one of discrete serial reactances and parallel reactances, and
at least one of discrete serial susceptances and parallel susceptances, and
effective line quantities per unit length, including at least one of capacitance per unit length, transverse capacitance per unit length, inductance per unit length, or longitudinal inductance per unit length.

2. The device of claim 1, wherein a dimensional value of at least one of the line sections, the stubs, the line segments, the discrete elements, the reactances, the susceptances, and the line quantities per unit length is smaller than the wavelength in the line.

3. The device of claim 1, wherein a distance of at least one of the line sections, the stubs, the line segments, the discrete elements, the reactances, the susceptances, and the line quantities per unit length from one another are smaller than the wavelength in the line.

4. The device of claim 1, wherein the line has at least two antenna elements, which include beam elements for which there is at least one of at least a partial series feed, at least a partial corporate feed, at least a partial phase-symmetrical feed, and an amplitude-symmetrical feed.

5. The device of claim 1, wherein an effective dielectric constant of the line and thus the phase shift between the antenna elements is variable and is enlargeable, by arranging dielectric material, in the form of a cap at a variable distance at least one of from the line and from the antenna elements, on at least one of (i) a top side of the substrate facing the antenna elements, above the line with air between the dielectric material and the line, and (ii) a bottom side of the substrate facing away from the antenna elements, below the line with air between the dielectric material and the line.

6. The device of claim 1, wherein the effective dielectric constant of the line and thus the phase shift between the antenna elements is variable and is reducible, by arranging conductive material, at least one of made at least partially of metal and in the form of at least one partially or completely metal-coated plastic cap, at a variable distance at least one of from the line and from the antenna elements, on (i) a top side of the substrate facing the antenna elements, above the line with air between the conductive element and the line, and (ii) a bottom side of the substrate facing away from the antenna elements, below the line with air between the conductive element and the line.

7. The device of claim 1, wherein at least one metallic coating layer is provided on a bottom side of the substrate facing away from the antenna elements.

8. A beam device for at least one of emitting and receiving electromagnetic radiation, including electromagnetic High Frequency radar radiation, comprising:
at least one device for providing phase shifting on at least one single-layer or multilayer substrate to which is applied at least one planar line, the device including:
an arrangement to adjust the phase shift by varying an effective dielectric constant of the line, the arrangement including at least one of:
line sections going out from the line, and
stubs going out from the line, and
alternating line segments of a high impedance and line segments of a low impedance, and
one of: (i) discrete elements, including at least one of inductors and capacitors, or (ii) at least one of inductive line bridges and capacitive line bridges, and
at least one of discrete serial reactances and parallel reactances, and
at least one of discrete serial susceptances and parallel susceptances, and
effective line quantities per unit length, including at least one of capacitance per unit length, transverse capacitance per unit length, inductance per unit length, or longitudinal inductance per unit length;
wherein the device is arranged as at least one of a mechanical slow-wave phase shifter and a mechanical stub-loaded line phase shifter.

9. A method for providing phase shifting on at least one single-layer or multilayer substrate, the substrate having at least one metallic layer and having at least one planar line, the line being in the form of a strip line, a symmetrical coplanar line, an asymmetrical coplanar line, a microstrip line, a slot line, or a coplanar dual-strip line, the method comprising:
adjusting the phase shift by varying an effective dielectric constant, which includes a propagation coefficient of the line, via at least one of:
line sections going out from the line, including at least one of no-load line sections and line sections short-circuited at their particular ends, and
stubs going out from the line, and
alternating line segments of a high impedance and line segments of a low impedance, and
discrete elements, including at least one of inductors, capacitors, inductive line bridges, and capacitive line bridges, and
at least one of discrete serial resistances and parallel reactances, and
at least one of discrete serial susceptances and parallel susceptances, and
effective line quantities per unit length, including at least one of capacitance per unit length, transverse capacitance per unit length, inductance per unit length, and longitudinal inductance per unit length.

10. The method of claim 9, wherein the method is used to radar sense an ambient area around a transportation arrangement, so as to provide at least one of the following:
an object-unique measurement of at least one of the distance and speed of at least one object in an environment of the transportation arrangement,
automatic regulation of at least one of a distance and a speed of the transportation arrangement,
stop-and-go operation of the transportation arrangement,
increasing safety in operation of the transportation arrangement by at least one of arming an airbag, arming a seat belt tightener, optimizing a deployment time of at least one of an airbag and a seat belt tightener, and warning of and preventing a collision, including with another transportation arrangement.

11. The device of claim 1, wherein the substrate includes at least one metallic layer.

12. The device of claim 1, wherein the at least one planar line is in the form of one of a strip line, a symmetrical coplanar line, an asymmetrical coplanar line, a microstrip line, a slot line, a coplanar dual-strip line.

13. The device of claim 1, wherein the effective dielectric constant includes a propagation coefficient.

14. The device of claim 1, wherein the line sections going out from the line include at least one of no-load line sections and line sections short-circuited at their particular ends.

15. The device of claim 3, wherein the distance is a periodic distance.

16. The device of claim 4, wherein, the feed is accomplished by one of the following:
direct or capacitive coupling of at least one feed network on a top side of the substrate facing the antenna elements;
electromagnetic coupling provided by at least one slot, each being of at least one feed network from a bottom side of the substrate facing away from the antenna elements; and
at least one dielectric bushing, each being from the bottom side of the substrate facing away from the antenna elements.

17. The device of claim 1, wherein the device is used to radar sense an ambient area around a transportation arrangement, so as to provide at least one of the following:
an object-unique measurement of at least one of the distance and speed of at least one object in an environment of the transportation arrangement,
automatic regulation of at least one of a distance and a speed of the transportation arrangement,
stop-and-go operation of the transportation arrangement,
increasing safety in operation of the transportation arrangement by at least one of arming an airbag, arming a seat belt tightener, optimizing a deployment time of at least one of an airbag and a seat belt tightener, and warning of and preventing a collision, including with another transportation arrangement.
